(19) United States
(12) Patent Application Publication
(10) Pub. No.: US 2023/0419730 A1
(43) Pub. Date: Dec. 28, 2023

(54) MOTION ERROR DETECTION FROM PARTIAL BODY VIEW

(71) Applicant: Amazon Technologies, Inc., Seattle, WA (US)

(72) Inventors: Ido Yerushalmy, Tel-Aviv (IL); Amir Dudai, Jerusalem (IL); Eli Alshan, Kfar-Saba (IL)

(21) Appl. No.: 17/850,596

(22) Filed: Jun. 27, 2022

(51) Int. Cl. G06V 40/20; G06T 7/73; G06V 10/26; G06V 40/10; G06V 10/70; A63B 71/06

(52) U.S. Cl. CPC G06V 40/23; G06T 7/75; G06V 10/26; G06V 40/10; G06V 10/70; A63B 71/0622; G06T 2207/30196; G06T 2207/20081; A63B 2220/05; A63B 2220/807; A63B 2220/17; A63B 2071/0694; A63B 2071/0625; A63B 2071/0655

(57) ABSTRACT

Described are systems and methods directed to the processing of two-dimensional (“2D”) images of a body to determine a physical activity performed by the body, repetitions of the physical activity, whether the body is performing the physical activity with proper form, and providing physical activity feedback. In addition, the disclosed implementations are able to determine the physical activity, repetitions, and/or form through the processing of 2D partial body images that include less than all of the body of the user.

### BACKGROUND

Physical activity tracking using wearable devices and/or home gym equipment has continued to increase in use. While many of these devices have the ability to provide some form of feedback regarding the activity, such as steps taken, calories burned, etc., proper determinations are generally based upon movement tracking or heartrate measurements of the user.

### BRIEF DESCRIPTION OF THE DRAWINGS

FIG. 1 is an example two-dimensional image of a body generated by a two-dimensional camera and physical activity form feedback presented in response to processing of the two-dimensional image, in accordance with implementations of the present disclosure.

FIG. 2A is a block diagram illustrating a processing of two-dimensional body images to produce physical activity feedback, in accordance with implementations of the present disclosure.

FIG. 2B is another block diagram illustrating a processing of two-dimensional body images to produce physical activity feedback, in accordance with implementations of the present disclosure.

FIG. 3 is a diagram of an image of a body of a user with body landmarks indicated both inside and outside of the image, in accordance with implementations of the present disclosure.

FIG. 4 is an example labeled training data that may be used to train a model to detect visible body landmarks, occluded body landmarks, and/or out-of-view body landmarks, in accordance with implementations of the present disclosure.

FIG. 5 is a block diagram of components of an image processing system, in accordance with implementations of the present disclosure.

FIG. 6 is an example physical activity feedback process, in accordance with implementations of the present disclosure.

FIG. 7 is another example physical activity feedback process, in accordance with implementations of the present disclosure.

FIG. 8 is an example physical activity repetition process, in accordance with implementations of the present disclosure.

FIG. 9 is an example form detection process, in accordance with implementations of the present disclosure.

FIG. 10 is an example flow diagram of a three-dimensional model generation process, in accordance with implementations of the present disclosure.

FIG. 11A is an example flow diagram of a three-dimensional model adjustment process, in accordance with implementations of the present disclosure.

FIG. 11B is another example flow diagram of a three-dimensional model adjustment process, in accordance with implementations of the present disclosure.

### DETAILED DESCRIPTION

As is set forth in greater detail below, implementations of the present disclosure are directed to the processing of two-dimensional (“2D”) image data of a body of a user to determine a physical activity performed by the body, repetitions of the activity, whether the body of the user is performing the activity with proper form and providing physical activity feedback to the user. In addition, the disclosed implementations are able to determine the physical activity, repetitions, and/or form through the processing of the 2D partial body image that includes less than all of the body of the user. For example, the disclosed implementations may determine body landmarks (e.g., ankle, elbow, eyes, ears, etc.) that are visible in the 2D body image and determine the position of other body landmarks of the body that are either occluded by the body in the image or out-of-view of the 2D camera that generated the 2D body image.

The term 2D body image, as used herein, refers to both 2D body images that include a representation of an entire body of a user as well as 2D body images that include a representation of only a portion of the 2D body (i.e., less than the entire body of the user). A 2D partial body image, as used herein, refers specifically to 2D body images that include a representation of less than the entire body of the user.

In some implementations, a user, also referred to herein as a person, may use a 2D camera, such as a digital camera typically included in many of today's portable devices (e.g., cell phones, tablets, laptops, etc.), a 2D webcam, video camera, and/or any other form of 2D camera, and obtain a series or video stream of 2D body images of their body while the user is performing a physical activity, such as an exercise. In some examples, the user may be following a guided exercise program, and as part of that guided exercise program may utilize a 2D camera to obtain images/video of the body of the user as the user performs the guided exercises.

As noted above, only a portion of the body need be visible and represented in the images. For example, the disclosed implementations may utilize images in which a portion of the body, such as the lower legs, hands, head, etc., are not represented in the image and/or are occluded by other objects represented in the image. Such 2D partial body images may be produced, for example, if the user is positioned such that a portion of the body of the user is outside the field of view of the camera. In other examples, if another object (e.g., table, desk) is between a portion of the body of the user and the 2D camera, a 2D partial body image may be produced in which less than all of the body of the user is represented in the image. In still other examples, the position of the body of the user, such as kneeling, sitting, etc., when the images are generated may result in one or more 2D partial body images.

Two-dimensional body images of the body of the user may be processed using one or more processing techniques, as discussed further below, to generate a plurality of visible body landmarks corresponding to the body represented in the 2D body images, occluded body landmarks, and to predict body landmarks for portions of the body that are not represented in the 2D body images.

The resulting body landmarks may then be further processed to determine a physical activity being performed by the body of the user, a number of repetitions of that physical activity, and/or whether proper form is being used in performing the physical activity. Physical activity feedback may then be generated and sent for presentation to the user indicating, for example, the physical activity, repetition counts of the activity, whether proper form is being followed, and/or indications as to changes in body position/movement that are needed to correct an error in the form followed in performing the physical activity so that the body of the user is not potentially injured while performing the physical activity.

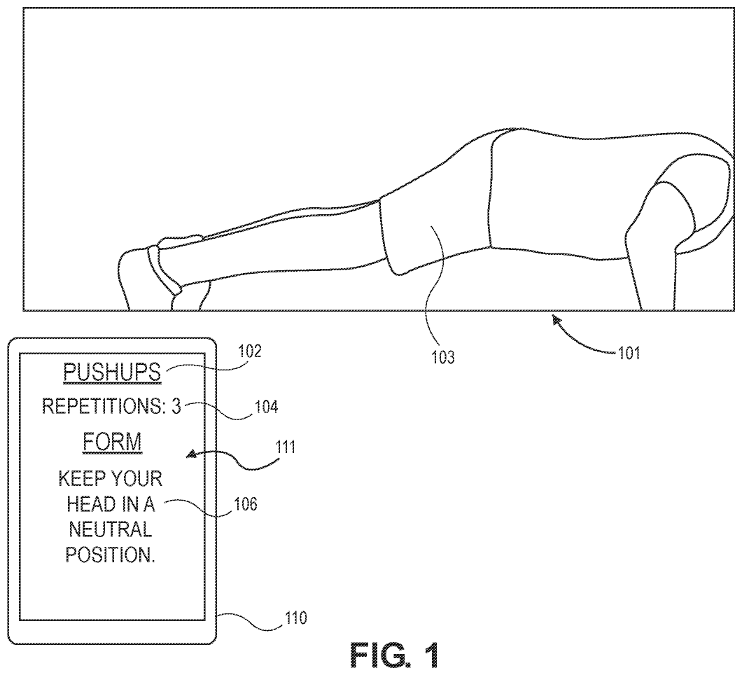

FIG. 1 is an example two-dimensional image 101 of a body generated by a two-dimensional camera and physical activity form feedback 111 presented on a device 110 in response to processing of the two-dimensional image, in accordance with implementations of the present disclosure.

In this example, the 2D body image 101 is a 2D partial body image and includes a partial representation of a body 103 of the user. In the illustrated example, a head of the body, the hands of the body, and a portion of the feet of the body of the user are not represented in the image because they are out of a field of view of the 2D camera that generated the image. In addition, the body 103 represented in the 2D partial body image is performing the physical activity of a pushup. As used herein, a “physical activity” may include any physical activity performed by a user, such as, but not limited to, an exercise (e.g., pushups, sit-ups, lunges, squats, curls, yoga poses, etc.), a work related physical activity (e.g., lifting an item from the floor, placing an item on a shelf, etc.), or any other physical activity that may be performed by a body.

As discussed further below, in accordance with the disclosed implementations, the 2D partial body image 101 may be processed to determine one or more of the physical activities 102 being performed, a number of repetitions 104 of the physical activity performed by the body, and/or whether the body is using proper form in performing the physical activity. Based on the processing of the 2D partial body image, physical activity feedback 111 may be sent for presentation, or presented, that includes, one or more of an indication of the physical activity 102 being performed by the body, a number of repetitions 104 of the physical activity, whether the physical activity is being performed by the body with a proper physical activity form, and/or instructions/changes 106 in the movement of the body to correct an error in the physical activity form performed by the body. In the illustrated example, a user device 110 is used to present physical activity feedback 111 in response to processing of the 2D partial body image 101. In this example, the physical activity feedback 111 indicates the determined physical activity 102, in this example pushups, a number of repetitions 104 of the physical activity, in this example three, and instructions 106 indicating changes in a movement of the body to correct an error determined in the form of the body in performing the physical activity. In this example, processing of the 2D partial body image determines that that user has his head lowered, which is an error in the form for a pushup, and instructions, such as “Keep your head in a neutral position.” may be presented. As discussed below, this determination may be made even though, in this example, the head of the body is not in the 2D partial body image 101.

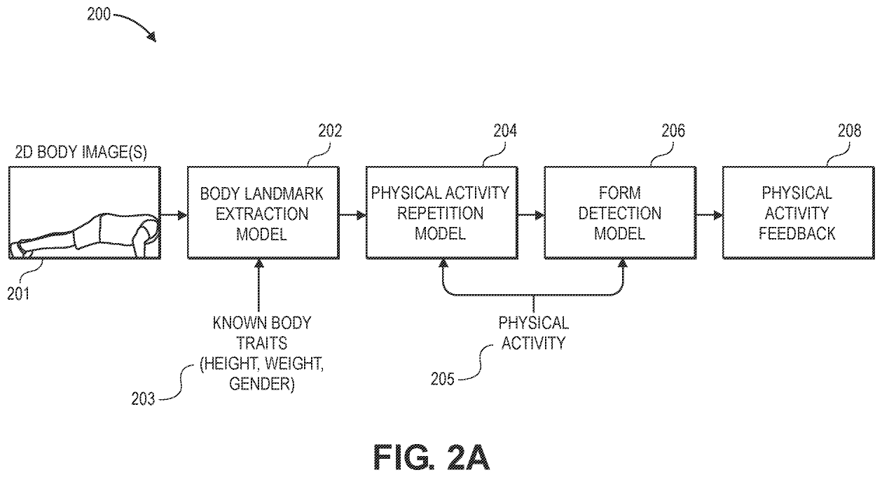

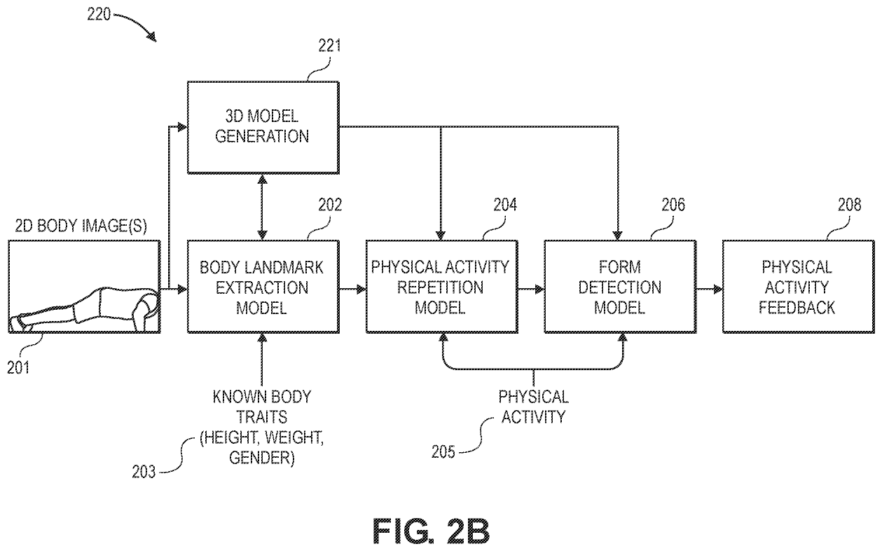

FIG. 2A is a block diagram 200 illustrating a processing of two-dimensional body images 201 to produce physical activity feedback 208, in accordance with implementations of the present disclosure.

As discussed further below, 2D body images 201 are processed using a body landmark extraction model 202 that determines body landmarks for the body represented in the 2D body image. In some implementations, the body landmark extraction model may utilize, in addition to the 2D body image, known body traits 203, such as height, weight, gender, etc., for the body represented in the 2D body image 201. For example, a user may provide one or more body traits about the body of the user represented in the 2D body image. Body landmarks for a body may include, but are not limited to, top of head, ears, left shoulder, right shoulder, right elbow, left elbow, right wrist, left wrist, left hip, right hip, left knee, right knee, left ankle, right ankle, and/or any other determinable location on a body.

In some implementations, the body landmark extraction model may be a machine learning model, such as a convolutional neural network (“CNN”) that is trained to predict the location or position of any number of body landmarks corresponding to the body represented in the 2D body image. As discussed further below, the body landmark extraction model 202 may predict body landmark positions for visible body landmarks, occluded body landmarks that are within the field of view of the 2D camera but not visible to the 2D camera, and/or body landmarks for portions of the body that are outside the field of view of the 2D camera and not included in the 2D body image. Body landmarks may be predicted based on, for example, the position of body segment(s) (e.g., arm, leg, torso, etc.) that connect different body landmarks, the position of other body segments and/or other body landmarks, etc.

Based on the determined body landmarks and either determining or receiving an indication of a physical activity being performed, the physical activity repetition model 204 may determine a number of repetitions of the physical activity performed by the body represented in the 2D body images. For example, the physical activity repetition model may consider body landmarks of a body determined in a series of 2D body images and determine a start repetition image indicative of a start of a repetition of the physical activity and an end repetition image indicative of an end of the repetition of the physical activity. For example, the physical activity repetition model 204 may be another machine learning model (e.g., CNN) that is trained to identify a start of a repetition based on first positions of body landmarks in an image as well as an end of a repetition based on second positions of body landmarks in a body image. As body landmarks for 2D body images for a physical activity are processed, the physical activity repetition model may determine the start and end of each repetition and increment a repetition counter for that physical activity. In addition, the physical activity repetition model 204 may be configured to determine repetitions as a number of times an activity is performed and/or a duration of time for which an activity is performed. For example, if the activity performed by the body is pushups, the physical activity repetition model 204 may be configured to determine a number of times the body completes a pushup, referred to herein as repetitions. As another example, if the activity being performed is a plank, where the body is maintained in a mostly stationary position for a duration of time, the physical activity repetition model 204 may determine a duration of time for which the body is maintained in the stationary position, also referred to herein as a repetition.

In addition to determining repetitions, a form detection model 206 may further process body landmarks determined from the 2D body images of the body performing the physical activity and, knowing the physical activity 205, determine if the body is in proper form positions for the physical activity being performed. For example, the form detection model 206 may be another machine learning model (e.g., CNN) that is trained to determine whether a body is following a proper form for a physical activity based on the position of the body landmarks determined for the body and/or based on input 2D body images of the body. For example, the form detection model 206 may process body landmarks determined for 2D body images between a repetition start and a repetition end, as determined by the physical activity repetition model 204 and determine if the positioning of the determined body landmarks are within a degree of accuracy of an expected position of body landmarks with respect to each other if the body is following a proper form in performing the physical activity 205. As another example, the form detection model 206 may also process one or more 2D body images of the body to determine if the body is in a proper form, which may be completed in addition to considering body landmarks or as an alternative to considering body landmarks.

Finally, physical activity feedback 208 may be generated and sent for presentation. The physical activity feedback 208 may indicate one or more of the determined physical activities, the number of repetitions for the physical activity, the time duration of repetitions, whether the physical activity is being performed with the proper form, instructions for changing a movement of the body to correct the form in performing the physical activity, etc.

FIG. 2B is another block diagram 220 illustrating a processing of two-dimensional body images 201 to produce physical activity feedback 208, in accordance with implementations of the present disclosure.

As discussed further below, 2D body images 201 are processed using a body landmark extraction model 202 that determines body landmarks for the body represented in the 2D body image. In some implementations, the body landmark extraction model may utilize, in addition to the 2D body image, known body traits 203, such as height, weight, gender, etc., for the body represented in the 2D body image 201. For example, a user may provide one or more body traits about the body of the user represented in the 2D body image. Body landmarks for a body may include, but are not limited to, top of head, ears, left shoulder, right shoulder, right elbow, left elbow, right wrist, left wrist, left hip, right hip, left knee, right knee, left ankle, right ankle, and/or any other determinable location on a body.

In some implementations, the body landmark extraction model may be a machine learning model, such as a CNN that is trained to predict the location or position of any number of body landmarks corresponding to the body represented in the 2D body image. As discussed further below, the body landmark extraction model 202 may predict body landmark positions for visible body landmarks, occluded body landmarks that are within the field of view of the 2D camera but not visible to the 2D camera, and/or body landmarks for portions of the body that are outside the field of view of the 2D camera and not included in the 2D body image. Body landmarks may be predicted based on, for example, the position of the body segment(s) (e.g., arm, leg, torso, etc.) that connect different body landmarks, the position of other body segments and/or other body landmarks, etc.

In the example discussed with respect to FIG. 2B, the 2D body images 201 and/or the determined body landmarks may be used for three-dimensional (“3D”) model generation 221. For example, and as discussed further below, a CNN may process the 2D body image and the determined body landmarks and generate a 3D model corresponding to the body represented in the 2D body image(s). The 3D model may be a model of the entire body, even if portions of the body are not represented in the 2D body image. For example, the 3D model may be generated based on the positioning of the body landmarks generated for the body and portions of the 3D body model predicted based on the position of those body landmarks and the position of other body landmarks determined for the body.

Based on the determined body landmarks, the 3D model, and either determining or receiving an indication of a physical activity being performed, the physical activity repetition model 204 may determine a number of repetitions of the physical activity performed by the body represented in the 2D body images and/or represented in the 3D body model. For example, the physical activity repetition model may consider body landmarks of a body determined in a series of 2D body images and determine a start repetition image indicative of a start of a repetition of the physical activity and an end repetition image indicative of an end of the repetition of the physical activity. Alternatively, or in addition thereto, the physical activity model may also consider the pose or position of body segments included in the 3D model and based on those poses/positions, determine start and ends of repetitions. For example, the physical activity repetition model 204 may be another machine learning model (e.g., CNN) that is trained to identify a start of a repetition based on first positions of body landmarks in an image and/or based on pose/position of body segments of a 3D model, as well as an end of a repetition based on second positions of body landmarks in a body image and/or second poses/positions of segments of the 3D model. As body landmarks/3D model determined from 2D body images for a physical activity are processed, the physical activity repetition model may determine the start and end of each repetition and/or the duration of the repetition, and increment a repetition counter for that physical activity.

In addition to determining repetitions, a form detection model 206 may further process body landmarks and/or 3D body models determined from the 2D body images of the body performing the physical activity and, knowing the physical activity 205, determine if the body is in proper form positions for the physical activity being performed. For example, the form detection model 206 may be another machine learning model (e.g., CNN) that is trained to determine whether a body is following a proper form for a physical activity based on the positions of the body landmarks determined for the body and/or based on the poses/positions of body segments of the 3D model. For example, the form detection model 206 may process body landmarks and/or poses/positions of 2D models determined for 2D body images between a repetition start and a repetition end, as determined by the physical activity repetition model 204, and determine if the positioning of the determined body landmarks/body segments are within a degree of accuracy of an expected position of body landmarks with respect to each other if the body is following a proper form in performing the physical activity. Alternatively, or in addition thereto, the form detection model 206 may also process one or more images of the body to, for example, detect edges of the body, and determine based on the positions or curves of the body, as determined from the detected edges, whether the body is within a degree of accuracy of an expected body position of the body.

Finally, physical activity feedback 208 may be generated and sent for presentation. The physical activity feedback 208 may indicate one or more of the determined physical activities, the number of repetitions for the physical activity, whether the physical activity is being performed with the proper form, instructions for changing a movement of the body to correct the form in performing the physical activity, etc.

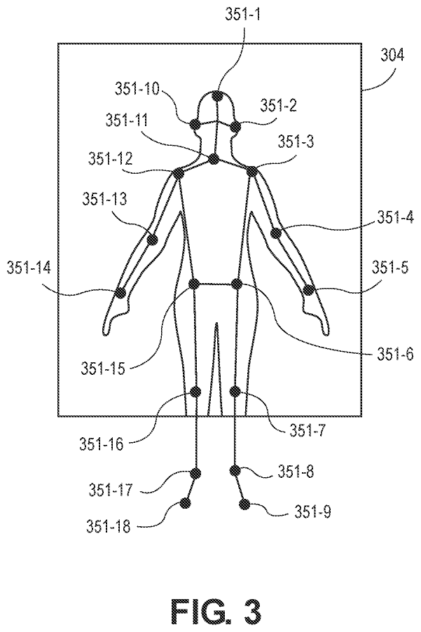

FIG. 3 is a diagram of an image 304 of a body of a user with body landmarks 351 indicated both inside and outside of the image, in accordance with implementations of the present disclosure.

As discussed, the 2D body image may be processed to determine body landmarks 351 of the body. For example, the image 304 may be provided to a trained machine learning model, such as a CNN that is trained to determine body landmarks of a body represented in an image. Based on the provided input, the CNN may generate an output indicating the location (e.g., x, y coordinates, or pixels) corresponding to the body landmarks for which the CNN was trained. In the illustrated example, the CNN may indicate body landmarks for the top of head 351-1, left ear 351-2, left shoulder 351-3, left elbow 351-4, left wrist 351-5, left hip 351-6, left knee 351-7, right ear 351-10, neck 351-11, right shoulder 351-12, right elbow 351-13, right wrist 351-14, right hip 351-15, and right knee 351-16, all of which are visible in the image 304. Likewise, in some implementations, the CNN may also infer the location of body landmarks that are not visible in the image 304, such as the left ankle 351-8, left foot 351-9, right ankle 351-17, and right foot 351-18. Such inference may not only indicate the inferred location of the body landmarks that are not visible but also indicate, such as through a visibility indicator, that the inferred positions of the body landmarks are determined to not be visible in the input image 304. Likewise, in some implementations, the CNN may provide a visibility indicator for body landmarks that are determined to be visible in the input image indicating that the body landmarks are visible.

In some implementations, utilizing the predicted body parameters and visibility indicators, a 3D model of the body may be generated. For example, the body parameters may be provided to a body model, such as the Shape Completion and Animation of People (“SCAPE”) body model, a Skinned Multi-Person Linear (“SMPL”) body model, etc., and the body model may generate the 3D model of the body of the user based on those predicted body parameters. To improve accuracy of the 3D model, in some implementations, data corresponding to any body landmark that is determined to not be visible (occluded or out-of-view), as indicated by the respective visibility indicator, may be ignored, or omitted by the body model in generation of the 3D model as the data for those body landmark body parameters may be unreliable or inaccurate. Instead, the model may determine body landmarks for those non-visible body joints based on the position of other body joints of the body of the user that are visible. In other implementations, the inferred position for one or more body landmarks that are determined to not be visible, such as those that are within the field of view of the image but occluded, may be considered in determining the 3D model.

In some implementations, as discussed further below, 3D model refinement and/or body landmark refinement may be performed to better represent the body of the user. Initially, for each body landmark determined to be visible in the image, as indicated by the corresponding visibility indicator, the position of the body landmark may be compared with the representation of the body of the user in the 2D body image to determine differences therebetween. The determined body landmarks may be updated to align the determined body landmarks with the position of those body landmarks as represented in the 2D body image.

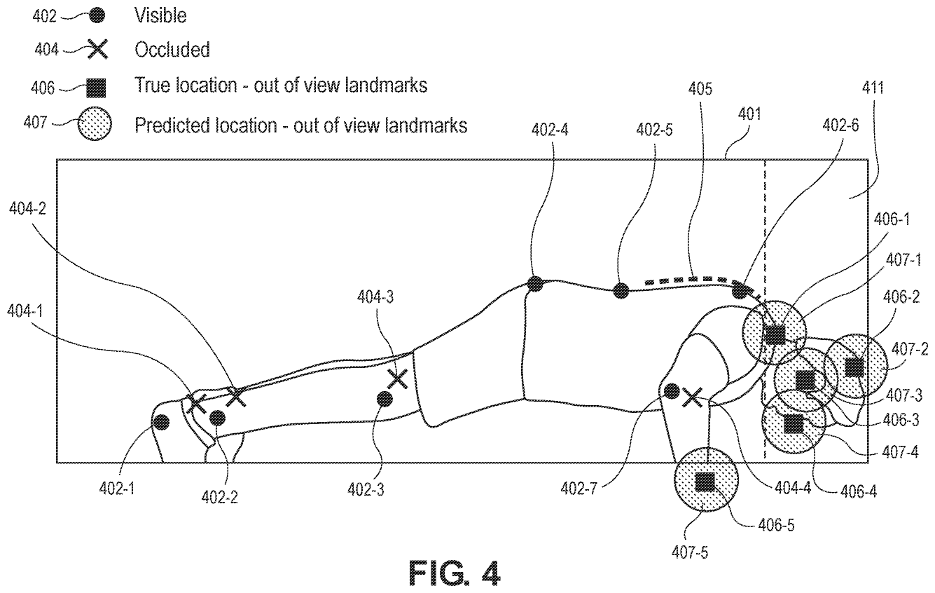

FIG. 4 is an example labeled training data 401 that may be used to train a machine learning model, such as a CNN, to detect visible body landmarks 402, occluded body landmarks 404, and/or out of frame body landmarks 406, in accordance with implementations of the present disclosure.

As illustrated, to generate labeled training data, images of a body may be generated and labeled with body landmarks, such as visible body landmarks 402, such as a right heel body landmark 402-1, a right ankle body landmark 402-2, a right knee body landmark 402-3, a right hip body landmark 402-4, a lower back body landmark 402-5, a right shoulder body landmark 402-6, and a right elbow body landmark 402-7, may be labeled for the image 401. Likewise, occluded body landmarks 404, which are body landmarks that are within the field of view of the 2D camera but occluded from view of the camera by the body and/or by another object, such as a left heel body landmark 404-1, left ankle body landmark 404-2, left knee body landmark 404-3, left elbow body landmark 404-4, etc., may also be labeled. Finally, body landmarks corresponding to a portion of the image that will be removed or cropped for training purposes, such as portion 411, may be labeled as true locations of those body landmarks. For example, the junction between the neck and shoulders body landmark 406-1, the top of head body landmark 406-2, right ear body landmark 406-3, nose body landmark 406-4, and right wrist body landmark 406-5 may be labeled based on the known position represented in the 2D body image before it is cropped for training purposes. In some implementations, the labeling of the body landmarks 402, 404, 406 may include an x coordinate, a y-coordinate, and an indication as to whether the body landmark is visible, occluded, or out of frame. Alternatively, the body landmarks may be indicated based on pixel positions of the image, along with an indication as to whether the body landmark is visible, occluded, or out of frame. In some implementations, the curvature of some or all of the body, such as the back curvature 405, may also be labeled in the image.

As the model is trained, the model learns to process the images and determine the position of visible body landmarks 402, predict the position of occluded body landmarks 404, generate predicted positions 407 of the out of frame body landmarks, such as predicted positions 407-1, 407-2, 407-3, 407-4, 407-5 for the out of frame body landmarks 406-1, 406-2, 406-3, 406-4, 406-5, and/or to determine the curvature 405 of the body represented in the received images. For example, the trained model may be trained to determine a predicted location of a body landmark and define an area or region around that predicted location based on a confidence of the predicted location. If the confidence of the location of the body landmark is high, the area surrounding the predicted location may be small. In comparison, if the confidence of the predicted location is low, the area around the predicted location may be larger. As an example, the confidence of the visible landmarks 402-1, 402-2, 402-3, 402-4, 402-5, 402-6 is high so there is little to no area around the predicted location. In comparison, the predicted location of the out of frame landmarks 406-1, 406-2, 406-3, 406-4, 406-5 may be determined with a lower confidence and have a corresponding area 407-1, 407-2, 407-3, 407-4, 407-5 surrounding the predicted location of the out of frame landmark 406-1, 406-2, 406-3, 406-4, 406-5 that is larger.

Predictions of occluded body landmarks may be determined based on positions of visible body landmarks. Predictions of out of frame body landmarks may be determined based on positions of visible body landmarks and/or based on predicted positions of occluded body landmarks.

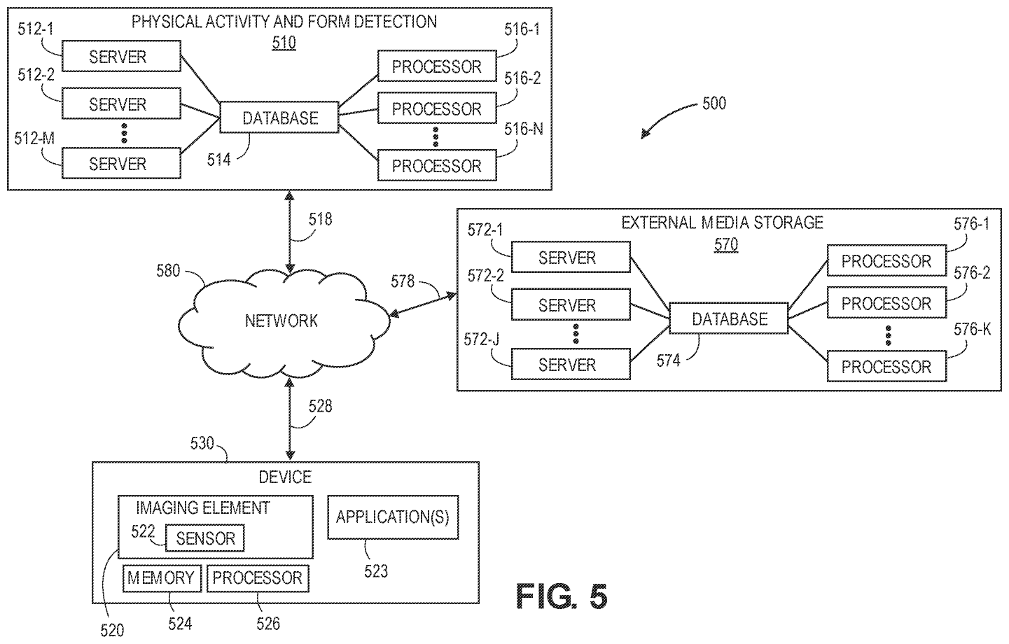

Referring to FIG. 5, a block diagram of components of one image processing system 500, in accordance with implementations of the present disclosure is shown.

The system 500 of FIG. 5 includes a physical activity and form detection system 510, an imaging element 520 that may be part of a device 530, such as a tablet, a laptop, a cellular phone, a webcam, a video camera, etc., and an external media storage facility 570 connected to one another across a network 580, such as the Internet.

The physical activity and form detection system 510 of FIG. 5 includes M physical computer servers 512-1, 512-2 . . . 512-M having one or more databases (or data stores) 514 associated therewith, as well as N computer processors 516-1, 516-2 . . . 516-N provided for any specific or general purpose. For example, the physical activity and form detection system 510 of FIG. 5 may be independently provided for the exclusive purpose of processing 2D body images captured by imaging elements, such as imaging element 520, and determining one or more of a physical activity being performed by a body represented in the 2D body images, a number of repetitions of the physical activity performed by the body, and/or whether a proper form is followed by the body when performing the physical activity. The servers 512-1, 512-2 . . . 512-M may be connected to, or otherwise communicate with the databases 514 and the processors 516-1, 516-2 . . . 516-N. The databases 514 may store any type of information or data, body parameters, 3D models, user data, body landmark positions for starts of a physical activity, body landmark positions for a stop or end of a physical activity, body positions and/or body landmarks corresponding to proper form of a physical activity, etc. The servers 512-1, 512-2 . . . 512-M and/or the computer processors 516-1, 516-2 . . . 516-N may also connect to, or otherwise communicate with the network 580, as indicated by line 518, through the sending and receiving of digital data.

The imaging element 520 may comprise any form of optical recording sensor or device that may be used to photograph or otherwise record information or data regarding a body of the user, or for any other purpose. As is shown in FIG. 5, the device 530 that includes the imaging element 520, is connected to the network 580 and includes one or more sensors 522, one or more memory or storage components 524 (e.g., a database or another data store), one or more processors 526, and any other components that may be required in order to capture, analyze and/or store imaging data, such as the 2D body images discussed herein. For example, the imaging element 520 may capture one or more still or moving images and may also connect to, or otherwise communicate with the network 580, as indicated by the line 528, through the sending and receiving of digital data. Although the system 500 shown in FIG. 5 includes just one imaging element 520 therein, any number or type of imaging elements, devices, or sensors may be provided within any number of environments in accordance with the present disclosure.

The device 530 may be used in any location and any environment to generate 2D body images that represent a body of the user. In some implementations, the device may be positioned such that it is stationary and approximately vertical (within approximately ten-degrees of vertical) and the user may position all or a portion of their body within a field of view of the imaging element 520 so that the imaging element 520 of the device may generate 2D body images that include a representation of at least a portion of the body of the user while performing a physical activity.

The device 530 may also include one or more applications 523 stored in memory 524 that may be executed by the processor 526 of the device to cause the processor 526 of the device to perform various functions or actions. For example, when executed, the application 523 may provide physical activity feedback to a user and/or provide physical activity instructions or guidance to the user.

The external media storage facility 570 may be any facility, station or location having the ability or capacity to receive and store information or data, such as segmented silhouettes, simulated or rendered 3D models of bodies, textures, body dimensions, etc., received from the physical activity and form detection system 510, and/or from the device 530. As is shown in FIG. 5, the external media storage facility 570 includes J physical computer servers 572-1, 572-2 . . . 572-J having one or more databases 574 associated therewith, as well as K computer processors 576-1, 576-2 . . . 576-K. The servers 572-1, 572-2 . . . 572-J may be connected to, or otherwise communicate with the databases 574 and the processors 576-1, 576-2 . . . 576-K. The databases 574 may store any type of information or data, including digital images, physical activity body landmark positions, 3D models, etc. The servers 572-1, 572-2 . . . 572-J and/or the computer processors 576-1, 576-2 . . . 576-K may also connect to, or otherwise communicate with the network 580, as indicated by line 578, through the sending and receiving of digital data.

The network 580 may be any wired network, wireless network, or combination thereof, and may comprise the Internet in whole or in part. In addition, the network 580 may be a personal area network, local area network, wide area network, cable network, satellite network, cellular telephone network, or combination thereof. The network 580 may also be a publicly accessible network of linked networks, possibly operated by various distinct parties, such as the Internet. In some implementations, the network 580 may be a private or semi-private network, such as a corporate or university intranet. The network 580 may include one or more wireless networks, such as a Global System for Mobile Communications (GSM) network, a Code Division Multiple Access (CDMA) network, a Long Term Evolution (LTE) network, or some other type of wireless network. Protocols and components for communicating via the Internet or any of the other aforementioned types of communication networks are well known to those skilled in the art of computer communications and, thus, need not be described in more detail herein.

The computers, servers, devices and the like described herein have the necessary electronics, software, memory, storage, databases, firmware, logic/state machines, microprocessors, communication links, displays or other visual or audio user interfaces, printing devices, and any other input/output interfaces to provide any of the functions or services described herein and/or achieve the results described herein. Also, those of ordinary skill in the pertinent art will recognize that users of such computers, servers, devices and the like may operate a keyboard, keypad, mouse, stylus, touch screen, or other device (not shown) or method to interact with the computers, servers, devices and the like, or to “select” an item, link, node, hub or any other aspect of the present disclosure.

The physical activity and form detection system 510, the device 530 or the external media storage facility 570 may use any web-enabled or Internet applications or features, or any other client-server applications or features including E-mail or other messaging techniques, to connect to the network 580, or to communicate with one another, such as through short or multimedia messaging service (SMS or MMS) text messages. For example, the servers 512-1, 512-2 . . . 512-M may be adapted to transmit information or data in the form of synchronous or asynchronous messages from the physical activity and form detection system 510 to the processor 526 or other components of the device 530, or any other computer device in real time or in near-real time, or in one or more offline processes, via the network 580. Those of ordinary skill in the pertinent art would recognize that the physical activity and form detection system 510, the device 530 or the external media storage facility 570 may operate on any of a number of computing devices that are capable of communicating over the network, including but not limited to set-top boxes, personal digital assistants, digital media players, web pads, laptop computers, desktop computers, electronic book readers, cellular phones, wearables, and the like. The protocols and components for providing communication between such devices are well known to those skilled in the art of computer communications and need not be described in more detail herein. In some implementations, two or more of the physical activity and form detection system(s) 510 and/or the external media storage 570 may optionally be included in and operate on the device 530.

The data and/or computer executable instructions, programs, firmware, software and the like (also referred to herein as “computer executable” components) described herein may be stored on a computer-readable medium that is within or accessible by computers or computer components such as the servers 512-1, 512-2 . . . 512-M, the processor 526, the servers 572-1, 572-2 . . . 572-J, or any other computers or control systems utilized by the physical activity and form detection system 510, the device 530, applications 523, or the external media storage facility 570, and having sequences of instructions which, when executed by a processor (e.g., a central processing unit, or “CPU”), cause the processor to perform all, or a portion of the functions, services and/or methods described herein. Such computer executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some implementations of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, or other types of media/machine-readable medium that may be suitable for storing electronic instructions. Further, implementations may also be provided as a computer executable program product that includes a transitory machine-readable signal (in compressed or uncompressed form). Examples of machine-readable signals, whether modulated using a carrier or not, may include, but are not limited to, signals that a computer system or machine hosting or running a computer program can be configured to access, or including signals that may be downloaded through the Internet or other networks.

While the example illustrated in FIG. 5 indicates three separate components 510, 530, 570, it will be appreciated that the disclosed implementations may be performed on additional or fewer components that communicate, for example, through the network 580. In some implementations, all aspects of the disclosed implementations may be performed on the device 530 so that no images, such as 2D body images, or other information that potentially identifies a body or a user is ever transmitted from the device 530.

In addition, in some implementations, high confidence data about a body may be labeled for the body landmark, repetition, etc., and provided as feedback to further refine and tune the machine learning model that is used to detect body landmarks of that user. Such feedback continues to improve the model and customize the model specific to that body. In addition, in some implementations, images of the body in specific locations, such as a home gym or home exercise location, may be provided to train the model to detect and potentially eliminate from consideration non-body aspects of the images (e.g., background objects, foreground objects).

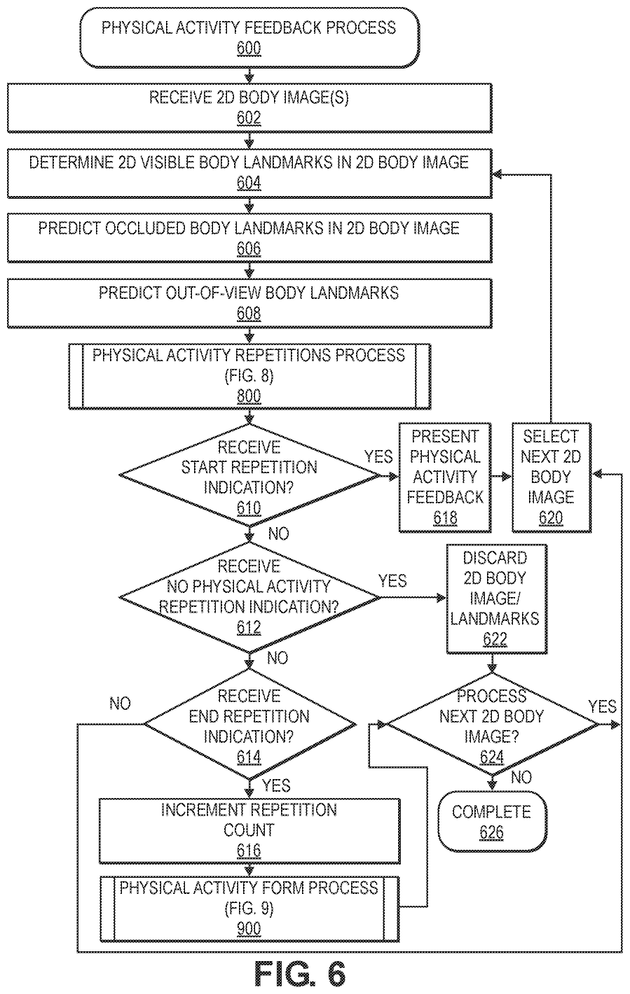

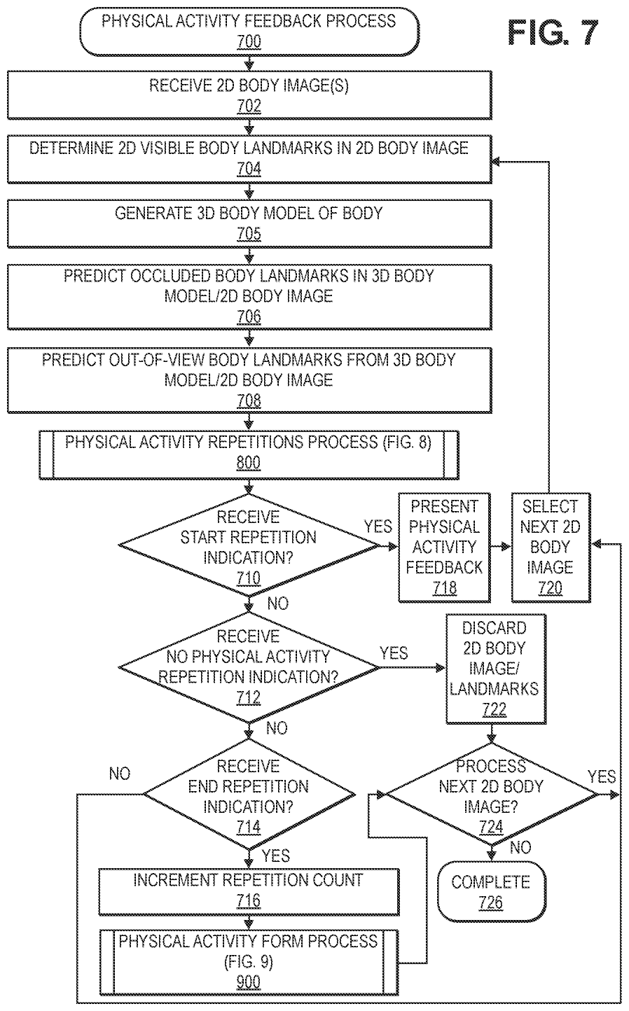

FIG. 6 is an example physical activity feedback process 600, in accordance with implementations of the present disclosure. While the example process 600, as well as the other example process 700-1150 (FIG. 7-FIG. 11B) may describe features or steps as being performed in series, in some implementations some, or all of those features or steps may be performed in parallel and/or in a different order, and the discussion provided herein is for explanation purposes only. Likewise, as discussed below, in some implementations, some features or steps may be omitted.

The example process 600 begins upon receipt of one or more 2D body images, which may include one or more 2D partial body images, as in 602. In some examples, if the user is exercising and following a guided exercise program, as part of that guided exercise program the user may be asked to position a 2D imaging device so that the body of the user is in the field of view of the 2D camera while the user performs the exercises. In another example, a 2D camera may be fixedly mounted in a location, such as a materials handling facility, and obtain images of a body, such as a picking agent, as the body is performing a physical activity (e.g., picking an item, lifting a box, etc.) within the field of view of the 2D camera.

A received 2D body image may then be processed to determine visible body landmarks represented in each body image, as in 604. For example, a machine learning model or other algorithm may be trained to detect any number of body landmarks (e.g., hip, knees, elbows, top of head, etc.) represented in the received 2D body image(s). For example, one or more body joint detection algorithms, such as TensorFlow, may be utilized to detect body joints that are visible within the image. Upon detection, the x-coordinate and y-coordinate corresponding to each visible body landmark may be generated and associated with the 2D body image.

In addition to determining visible body landmarks, occluded body landmarks that are within the field of view of the 2D camera but occluded by the body and/or another object may also be determined, as in 606. For example, a machine learning model, such as a CNN may be trained to determine occluded body landmarks based on inputs of a 2D body image and/or inputs of determined coordinates for visible body landmarks in a 2D body image. For example, and referring back to FIG. 4, coordinates for the visible body landmarks 402 may be input into a trained machine learning model, alone or in combination with the 2D body image, and the trained machine learning model may predict coordinates for the occluded body landmarks 404. As the occluded body landmarks are determined, the x-coordinate and y-coordinate for those occluded body landmarks, along with an indication that the body landmark is an occluded body landmark, is associated with the 2D body image and/or the determined visible body landmarks.

The example process 600 may also determine out-of-view body landmarks, as in 608. For example, a machine learning model, such as a CNN, may be trained to receive as inputs, the 2D body image and/or the determined coordinates for body landmarks (visible body landmarks and/or occluded body landmarks) and determine from the received inputs, predicted locations of the out-of-view body landmarks with respect to the determined body landmarks. In some implementations, a trained machine learning model may receive the coordinates for each determined visible body landmark and the coordinates for each determined occluded body landmark. In addition, the inputs may also include an indication as to which of the received body landmarks are visible and which are occluded. In such an implementation, the machine learning model may be trained to apply different weights to the visible body landmarks compared to occluded body landmarks that are received as inputs in predicting the position of out-of-view body landmarks. Based on the inputs, the machine learning model predicts positions or locations (e.g., x-coordinates and y-coordinates) of out-of-view body landmarks for the body.

For example, and again referring back to FIG. 4, coordinates for the visible body landmarks 402 and coordinates for the occluded body landmarks 404, and optionally an indication as to whether the body landmark is visible or occluded, may be input into a trained machine learning model, alone or in combination with the 2D body image, and the trained machine learning model may predict coordinates for the out-of-view body landmarks 406. As the out-of-view body landmarks are determined, the x-coordinate and y-coordinate for those out-of-view body landmarks, along with an indication that the body landmark is an out-of-view body landmark, is associated with the 2D body image and/or the determined body landmarks (visible and occluded).

In addition to outputting a predicted location or position of body landmarks, in some implementations, the machine learning model may also output a confidence score indicating a confidence that the predicted position or location is accurate. Utilizing the confidence score, an area or region around the predicted location or position of the predicted landmark may be defined, the surrounding area indicative of possible locations of the actual location of the predicted body landmark. As noted above, visible body landmarks will have a higher confidence value than occluded body landmarks, and both visible body landmarks and occluded body landmarks will have a higher confidence value than out of view landmarks. As such, the surrounding area for out of view body landmarks may be larger than the surrounding area for occluded body landmarks and visible body landmarks. Likewise, the surrounding area for occluded body landmarks may be larger than the surrounding area for visible body landmarks.

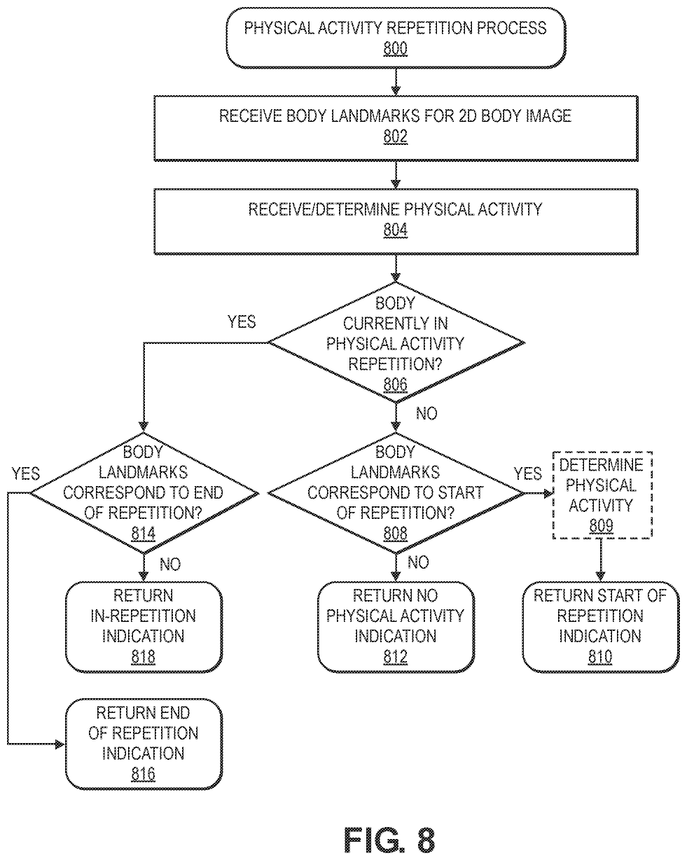

The determined visible body landmarks, occluded body landmarks, and out-of-view body landmarks are then processed by an example physical activity repetitions process 800 (FIG. 8). As discussed further below, the example physical activity repetitions process 800 processes the body landmarks and returns an indication as to whether the 2D body image corresponds to a start of a physical activity repetition, corresponds to an end of a physical activity repetition, corresponds to an in-repetition of a physical activity, or does not correspond to a physical activity repetition.

Upon completion of the physical activity repetitions process 800, a determination is made as to whether a physical activity start repetition indication was returned by the example process 800, indicating that the processed 2D body image corresponds to a start of a physical activity repetition, as in 610. If it is determined that the 2D body image corresponds to a start of physical activity repetition, physical activity feedback may be generated and sent for presentation, such as on a display, as in 618. For example, an indication of the physical activity being performed may be included in the physical activity feedback. If more than one repetition has been performed, the repetition count may be indicated in the feedback (as discussed further below), etc. A next 2D body image may then be selected, as in 620, and the example process may return to block 604 and continue.

If it is determined at decision block 610 that the indication received from the example process 800 is not a start repetition indication, a determination may be made as to whether the received indication is an indication that the 2D body image does not correspond to a physical activity repetition, as in 612. If it is determined that the 2D body image does not correspond to a repetition of a physical activity (i.e., it is not a start of a repetition, an end of a repetition, or an in-repetition 2D body image), the 2D body image may be discarded, as in 622, and a determination made as to whether to process a next 2D body image, as in 624. If it is determined that there are additional 2D body images to process, the example process 600 may return to block 620 and continue. If it is determined that a next 2D body image is not to be processed, the example process 600 completes, as in 626.

Returning to decision block 612, if it is determined that the indication received from the example process is not a no physical activity repetition indication, a determination may be made as to whether the indication received from the example process 800 is an end repetition indication, as in 614. If it is determined at decision block 614 that the received indication is not an end repetition indication, meaning that it was determined that the 2D body image corresponds to an in-repetition image of a physical activity repetition (i.e., is between a start repetition and an end repetition), the example process 600 returns to block 620 and continues.

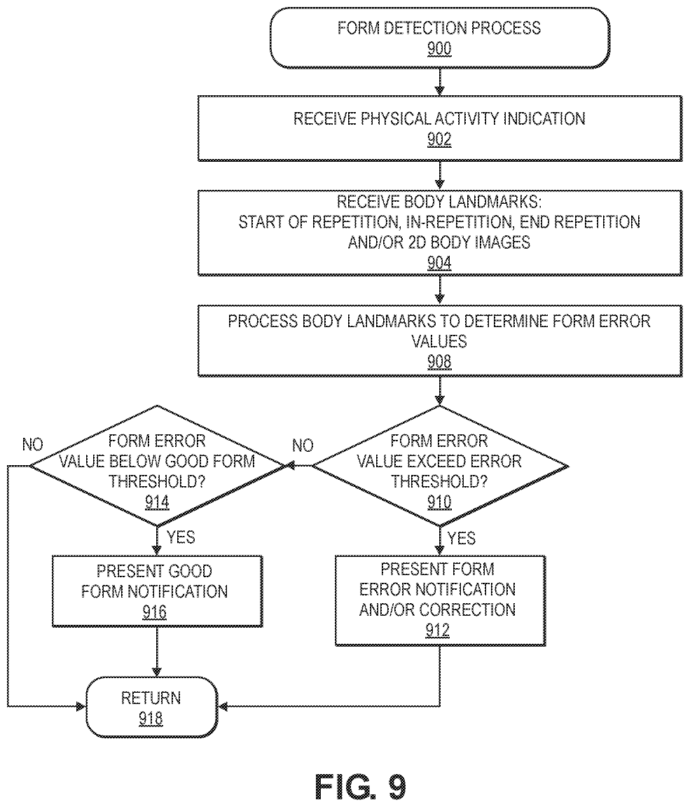

Finally, if it is determined at decision block 614 that the indication returned from the example process 800 is an end repetition indication, a repetition count in the physical activity feedback that is sent for presentation may be updated to indicate the completion of the repetition, as in 616. As discussed herein, the repetition count may indicate a number of times the activity was performed (e.g., number of pushups) and/or a duration of time an activity was performed (e.g., one-minute plank). Likewise, the example physical activity form process 900, discussed further below with respect to FIG. 9, may be performed. Upon completion of the example process 900, the example process 600 returns to block 624 and continues.

FIG. 7 is another example physical activity feedback process 700, in accordance with implementations of the present disclosure.

The example process 700 begins upon receipt of one or more 2D body images, which may include one or more 2D partial body images, as in 702. In some examples, if the user is exercising and following a guided exercise program, as part of that guided exercise program, the user may be asked to position a 2D imaging device so that the body of the user is in the field of view of the 2D camera while the user performs the exercises. In another example, a 2D camera may be fixedly mounted in a location, such as a materials handling facility, and obtain images of a body, such as a picking agent, as the body is performing a physical activity (e.g., picking an item, lifting a box, etc.) within the field of view of the 2D camera.

A received 2D body image may then be processed to determine visible body landmarks represented in each body image, as in 704. For example, a machine learning model or other algorithm may be trained to detect any number of body landmarks (e.g., hip, knees, elbows, top of head, etc.) represented in the received 2D body image(s). For example, one or more body joint detection algorithms, such as TensorFlow, may be utilized to detect body joints that are visible within the image. Upon detection, the x-coordinate and y-coordinate corresponding to each visible body landmark may be generated and associated with the 2D body image.

In the implementation described with respect to FIG. 700, the example process 700 also generates a 3D body model of the body that is at least partially represented in the 2D body image, as in 705. For example, as discussed herein, the determined body landmarks and segments of the body may be utilized to determine the body and 3D body model may be formed that is representative of the body. While the example process 700 illustrated in FIG. 7 indicates that determination of the visible body landmarks (block 704) and generation of the 3D body model (block 705) are performed in series, in other examples, determination of the visible body landmarks and generation of the 3D model may be performed in parallel.

In addition to determining visible body landmarks and generating a 3D body model, occluded body landmarks that are within the field of view of the 2D camera but occluded by the body and/or another object may also be determined, as in 706. For example, a machine learning model, such as a CNN may be trained to determine occluded body landmarks based on inputs of a 2D body image, inputs of determined coordinates for visible body landmarks in a 2D body image, and/or based on an input 3D body model. For example, and referring back to FIG. 4, coordinates for the visible body landmarks 402 may be input into a trained machine learning model, alone or in combination with the 2D body image, and/or the 3D body model and the trained machine learning model may predict coordinates for the occluded body landmarks 404. As the occluded body landmarks are determined, the x-coordinate and y-coordinate for those occluded body landmarks, along with an indication that the body landmark is an occluded body landmark, is associated with the 2D body image, the 3D body model, and/or the determined visible body landmarks.

The example process 700 may also determine out-of-view body landmarks, as in 708. For example, a machine learning model, such as a CNN, may be trained to receive as inputs the 2D body image, the 3D body model, and/or the determined coordinates for body landmarks (visible body landmarks and/or occluded body landmarks) and determine from the received inputs predicted locations of the out-of-view body landmarks with respect to the determined body landmarks. In some implementations, a trained machine learning model may receive the coordinates for each determined visible body landmark and the coordinates for each determined occluded body landmark and/or the 3D body model. In addition, the inputs may also include an indication as to which of the received body landmarks are visible and which are occluded. In such an implementation, the machine learning model may be trained to apply different weights to the visible body landmarks compared to occluded body landmarks that are received as inputs in predicting the position of out-of-view body landmarks. Based on the inputs, the machine learning model predicts positions or locations (e.g., x-coordinates and y-coordinates) of out-of-view body landmarks for the body.

For example, and again referring back to FIG. 4, coordinates for the visible body landmarks 402 and coordinates for the occluded body landmarks 404, and optionally an indication as to whether the body landmark is visible or occluded, may be input into a trained machine learning model, alone or in combination with the 2D body image, and the trained machine learning model may predict coordinates for the out-of-view body landmarks 406. As the out-of-view body landmarks are determined, the x-coordinate and y-coordinate for those out-of-view body landmarks, along with an indication that the body landmark is an out-of-view body landmark, is associated with the 2D body image and/or the determined body landmarks (visible and occluded).

In addition to outputting a predicted location or position of body landmarks, in some implementations, the machine learning model may also output a confidence score indicating a confidence that the predicted position or location is accurate. Utilizing the confidence score, an area or region around the predicted location or position of the body landmark may be defined, the surrounding area indicative of possible locations of the actual location of the predicted body landmark. As noted above, visible body landmarks will have a higher confidence value than occluded body landmarks, and both visible body landmarks and occluded body landmarks will have a higher confidence value than out of view landmarks. As such, the surrounding area for out of view body landmarks may be larger than the surrounding area for occluded body landmarks and visible body landmarks. Likewise, the surrounding area for occluded body landmarks may be larger than the surrounding area for visible body landmarks.

The determined visible body landmarks, occluded body landmarks, and out-of-view body landmarks are then processed by an example physical activity repetitions process 800 (FIG. 8). As discussed further below, the example physical activity repetitions process 800 processes the body landmarks and returns an indication as to whether the 2D body image corresponds to a start of a physical activity repetition, corresponds to an end of a physical activity repetition, corresponds to an in-repetition of a physical activity, or does not correspond to a physical activity repetition.

Upon completion of the physical activity repetitions process 800, a determination is made as to whether a physical activity start repetition indication was returned by the example process 800, indicating that the processed 2D body image corresponds to a start of a physical activity repetition, as in 710. If it is determined that the 2D body image corresponds to a start of physical activity repetition, physical activity feedback may be generated and sent for presentation, such as on a display, as in 718. For example, an indication of the physical activity being performed may be included in the physical activity feedback. If more than one repetition has been performed, the repetition count may be indicated in the feedback (as discussed further below), etc. A next 2D body image may then be selected, as in 720, and the example process may return to block 704 and continue.

If it is determined at decision block 710 that the indication received from the example process 800 is not a start repetition indication, a determination may be made as to whether the received indication is an indication that the 2D body image does not correspond to a physical activity repetition, as in 712. If it is determined that the 2D body image does not correspond to a repetition of a physical activity (i.e., it is not a start of a repetition, an end of a repetition, or an in-repetition 2D body image), the 2D body image may be discarded, as in 722, and a determination made as to whether to process a next 2D body image, as in 724. If it is determined that there are additional 2D body images to process, the example process 700 may return to block 720 and continue. If it is determined that a next 2D body image is not to be processed, the example process 700 completes, as in 726.

Returning to decision block 712, if it is determined that the indication received from the example process is not a no physical activity repetition indication, a determination may be made as to whether the indication received from the example process 800 is an end repetition indication, as in 714. If it is determined at decision block 714 that the received indication is not an end repetition indication, meaning that it was determined that the 2D body image corresponds to an in-repetition image of a physical activity repetition (i.e., is between a start repetition and an end repetition), the example process 700 returns to block 720 and continues.

Finally, if it is determined at decision block 714 that the indication returned from the example process 800 is an end repetition indication, a repetition count in the physical activity feedback that is sent for presentation may be updated to indicate the completion of the repetition, as in 716. As discussed herein, the repetition count may indicate a number of times the activity was performed (e.g., number of pushups) and/or a duration of time an activity was performed (e.g., one-minute plank). Likewise, the example physical activity form process 900, discussed further below with respect to FIG. 9, may be performed. Upon completion of the example process 900, the example process 700 returns to block 724 and continues.

FIG. 8 is an example physical activity repetition process 800, in accordance with implementations of the present disclosure.

As discussed above, the physical activity repetition process 800 may be performed to process a received 2D body image and/or body landmarks, as in 802, to determine if the 2D body image corresponds to a start of a physical activity repetition, an end of a physical activity repetition, a point during a physical activity repetition, or does not correspond to a physical activity repetition. The example process 800 may be performed as part of the example process 600 (FIG. 6), the process 700 (FIG. 7), or at any other time.

Upon receipt of the body landmarks and/or 2D body image, the example process 800 receives and/or determines a physical activity corresponding to the received 2D body image, as in 804. As discussed above, a user may provide an indication of the physical activity being performed. Alternatively, if the user is following an exercise program, the example process 800 may receive an indication of the physical activity that the user is to be performing as part of the program. As still another example, if the example process 800 has already been utilized to process a prior 2D body image and a start of a physical activity repetition has been determined, the determined physical activity may be utilized as the physical activity indicated in the 2D body image. In still other examples, the physical activity may not be determined at block 802 and may, if a physical activity is detected, be determined later in the example process 800, as discussed below with respect to block 809.

A determination is then made as to whether the body is already determined to be involved in a physical activity repetition, as in 806. As discussed above in block 802, a user may indicate that the body of the user is performing a physical activity, the example process may have previously determined that the body is performing a physical activity, another service, such as an exercise program, may provide an indication that the user is performing a physical activity, etc.

If it is determined that the body is currently performing a physical activity repetition, a determination may be made as to whether the received body landmarks correspond to an end of repetition for the physical activity, as in 814. For example, a position of each body landmark with respect to other body landmarks may be defined for an end of repetition position, referred to herein as end of repetition body landmarks. The received body landmarks corresponding to the 2D body image may be compared to the end of repetition body landmarks and if a defined percentage of the received body landmarks are within a defined distance of the expected positions of the corresponding body landmarks, as indicated in the end of repetition body landmarks, it may be determined that the 2D body image corresponds to an end of physical activity repetition.

If it is determined that the 2D body image corresponds to an end of physical activity repetition, the example process may return an end of repetition indication, as in 816. If it is determined that the 2D body image does not correspond to an end of physical activity repetition, the example process 800 may return an in-repetition indication indicating that the 2D body image is an image of the body during a repetition, as in 818. In some implementations, additional processing may be performed to determine if the body landmarks for the 2D body image correspond to expected or defined body landmarks for the determined physical activity.

Returning to decision block 806, if it is determined that the body is not currently indicated as performing a physical activity repetition, a determination may be made as to whether the body landmarks for the 2D body image correspond to a start of a physical activity repetition, as in 808. For example, start physical activity repetition body landmark positions may be defined for any number of physical activities, referred to herein as start of repetition body landmarks. The received body landmarks may be compared to those start of repetition body landmarks to determine both a physical activity for which the body is starting a repetition, as well as the start of the physical activity repetition. If the physical activity to be performed is already indicated (e.g., by the user or a service), the example process 800 may only compare the received body landmarks with the start of repetition body landmarks for the indicated physical activity repetition. If it is determined that the received body landmarks correspond to the start of a physical activity repetition and if no physical activity has been indicated, the physical activity defined by the start of repetition body landmarks that corresponds to the received body landmarks may be utilized as the physical activity being performed by the body, as in 809. Additionally, the example process 800 may return a start of physical activity repetition, as in 810, optionally along with an indication of the determined physical activity.

Returning to decision block 808, if it is determined that the body landmarks do not correspond to a start of a repetition, the example process 800 may return an indication that the received 2D body landmarks do not correspond to a physical activity, for example by returning a no physical activity indication, as in 812.

FIG. 9 is an example form detection process 900, in accordance with implementations of the present disclosure. The example process 900 may be performed at the completion of each repetition, as indicated by the example processes 600 (FIG. 6) and 700 (FIG. 7), at the end of a physical activity, during physical activity repetitions, or at any other time.

The example process 900 begins with receipt of an indication of a physical activity for which a form followed by the body performing the physical activity is to be analyzed, as in 902. As discussed above, the physical activity being performed by a body may be determined as part of the example process 600 (FIG. 6), 700 (FIG. 7), and/or 800 (FIG. 8).

In addition, the example process 900 may receive the body landmarks for some, or all of the 2D body images determined for a physical activity repetition, such as start of repetition body landmarks, in-repetition body landmarks, and end of repetition body landmarks, as in 904. As discussed above, body landmarks for each 2D body image may be determined as part of the example process 600 (FIG. 6) or the example process 700 (FIG. 7) and associated with each 2D body image for a physical activity repetition. Alternatively, or in addition thereto, the example process 900 may receive one or more 2D body images of the body.

The received body landmarks for 2D body images of a physical activity repetition may then be processed to determine form error values, as in 908. For example, expected body landmarks for different expected body positions during a physical activity repetition may be defined for each physical activity. The received body landmarks may be compared to the expected body landmarks for the physical activity repetition and an error value generated based on the similarity or difference between the expected body landmarks for the different positions and the received body landmarks that are closest in position to those expected body landmarks. For example, expected body landmarks at a start of a physical activity repetition may be compared to received body landmarks corresponding to the start of the physical activity repetition by the body and an error value generated based on the difference between the expected body landmark positions and the received body landmark positions.

Likewise, a second expected body landmark position that is in-repetition may be compared to received body landmark positions to identify a set of received body landmark positions that are most similar. An error value may then be determined based on a difference between the second expected body landmark positions and the most similar body landmark positions. This selection and comparison may be performed for any number of expected body landmark positions for the determined physical activity repetition and then a form error value determined based on each of the determined error values. For example, the form error value may be, for example, an average of each of the error values determined for the physical activity repetition, a median of each error value, etc.

Alternatively, or in addition thereto, edge detection may be performed on received 2D images to detect the edges and positions of the body represented in the 2D images as the body is performing the activity. The detected positions of the body detected in the 2D images may be compared to expected body positions and form error values determined based on the differences determined between the detected positions and the expected positions of the body.

Returning to FIG. 9, the example process 900 may then determine if the form error value exceeds an error threshold, as in 910. The error threshold may be any value and may vary for different users, different physical activities, etc. For example, physical activities that are known to have a high likelihood of bodily injury if poor form is used by the body when performing the physical activity, may have a lower error threshold than a physical activity that has a low injury correlation.

If it is determined that the form error value exceeds the error threshold, a form error notification and optionally corrective actions to be performed by the body, may be generated and sent for presentation to encourage the body to take corrective action, as in 912. For example, and referring back to FIG. 1, it may be determined from the body landmarks determined from the 2D body image 101 that the head of the body, even though out-of-view, is lowered (an error) and the back of the body is bowed (an error). It may further be determined that the error value determined during the repetition exceeds an error threshold and a form notification error, such as “Keep Your Head In a Neutral Position.” may be generated and sent for presentation. As another example, and still referring to FIG. 1, it may be determined from an image processing of the 2D body image 101, for example using edge detection, that the user is improperly curving their back (an error). It may further be determined that the error value determined during the repetition exceeds an error threshold and a form notification error, such as “Keep Your Back Straight” may be generated and sent for presentation.

In comparison, if it is determined at decision block 910 that the form error value does not exceed the error threshold, in some implementations, it may be determined whether the form error value is below a good form threshold, as in 914. A good form threshold may be any value and may be different for different users and/or different physical activities.

If it is determined that the form error value is below the good form threshold, a good form notification or indication may be generated for presentation indicating to the user that the body of the user is following a proper or good form while performing the physical activity repetition, as in 916. After presenting the good form notification in block 916, after presenting the form error notification at block 912, or if it is determined at decision block 914 that the form error value is not below the good form threshold, the example process 900 returns the determined results, as in 918. While the example 900 illustrates presentation of good form feedback or poor form feedback, any level or degree of feedback may be provided with the disclosed implementations. For example, multiple levels of feedback notifications may be provided, ranging from perfect form, to acceptable form, to incorrect form, to dangerous form. In other examples, additional or fewer levels and/or types of form feedback may be presented.

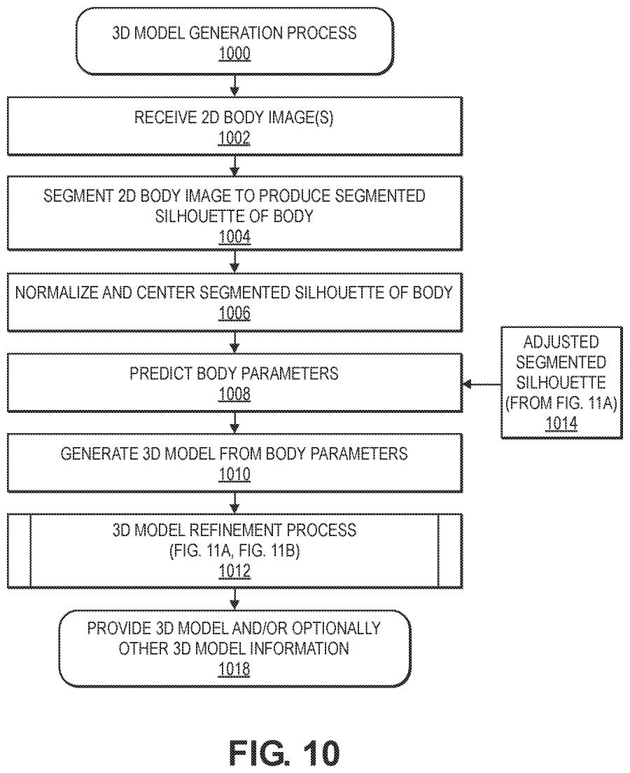

FIG. 10 is an example flow diagram of a three-dimensional model generation process 1000, in accordance with implementations of the present disclosure.

The example process 1000 begins upon receipt of one or more 2D body images of a body, as in 1002. The disclosed implementations are operable with any number of 2D body images for use in generating a 3D model of that body. For example, in some implementations, a single 2D body image may be used. In other implementations, two, three, four, or more 2D body images may be used.

As discussed above, the 2D body images may be generated using any 2D imaging element, such as a camera on a device, a webcam, etc. The received 2D body images may then be segmented to produce a segmented silhouette of the body represented in the one or more 2D body images, as in 1004. For example, the 2D body images may be processed by a CNN that is trained to identify body segments (e.g., hair, head, neck, upper arm, etc.) and generate a vector for each pixel of the 2D body image, the vector including prediction scores for each potential body segment (label) indicating a likelihood that the pixel corresponds to the body segment.

In addition, in some implementations, the segmented silhouettes may be normalized in height and centered in the image before further processing, as in 1006. For example, the segmented silhouettes may be normalized to a standard height based on a function of a known or provided height of the body of the user represented in the image and an average height (e.g., average height of female body, average height of male body). In some implementations, the average height may be more specific than just gender. For example, the average height may be the average height of a gender and an ethnicity corresponding to the body, or a gender and a location (e.g., United States) of the user, etc.

The normalized and centered segmented silhouette may then be processed by one or more neural networks, such as one or more CNNs, to generate predicted body parameters representative of the body represented in the 2D body images, as in 1008. There may be multiple steps involved in body parameter prediction. For example, each segmented silhouette may be processed using CNNs trained for the respective orientation of the segmented silhouette to generate sets of features of the body as determined from the segmented silhouette. The sets of features generated from the different segmented silhouettes may then be processed using a neural network, such as a CNN, to concatenate the features and generate the predicted body parameters representative of the body represented in the 2D body images.

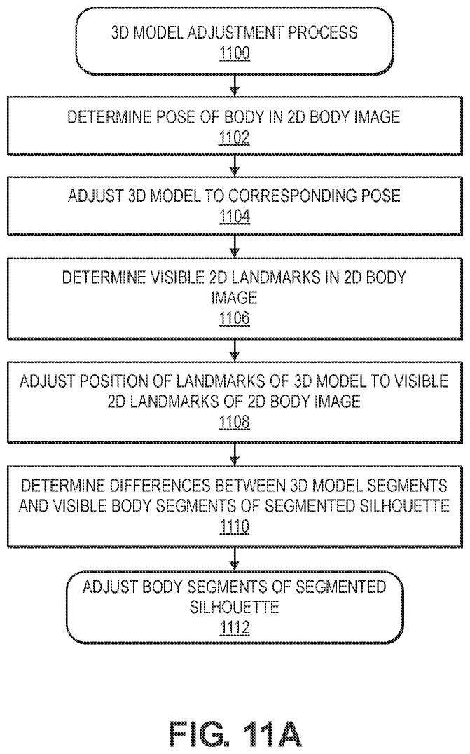

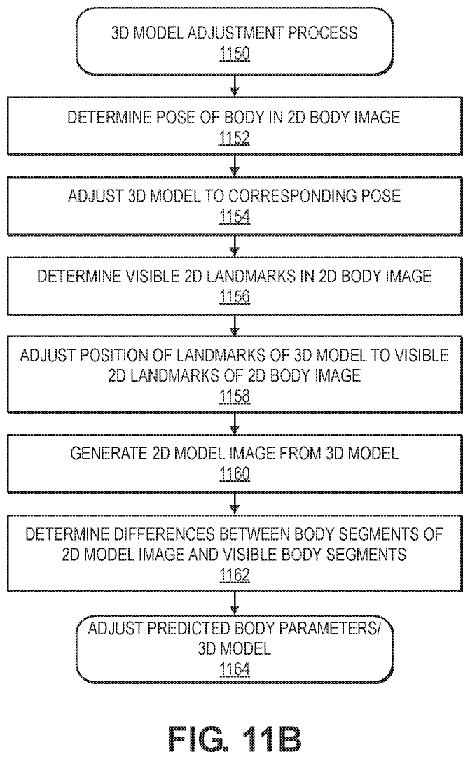

The predicted body parameters may then be provided to one or more body models, such as an SMPL body model or a SCAPE body model and the body model may generate a 3D model for the body represented in the 2D body images, as in 1010. In addition, in some implementations, the 3D model may be revised, if necessary, to more closely correspond to the actual image of the body of the user, as in 1012. 3D model refinement is discussed further below with respect to FIGS. 11A and 11B.

As discussed below, the 3D model adjustment process 1100 (FIG. 11A) returns an adjusted segmented silhouette, as in 1014. Upon receipt of the adjusted segmented silhouette, the example process 1000 again generates predicted body parameters, as in 1008, and continues. This may be done until no further refinements are to be made to the segmented silhouette. In comparison, the 3D model refinement process 1150 (FIG. 11B), generates and returns an adjusted 3D model.

After adjustment of the segmented silhouette and generation of a 3D model from adjusted body parameters, or after receipt of the adjusted 3D model from FIG. 11B, the 3D model may be returned and/or other 3D model information (e.g., body mass, body landmarks, arm length, body fat percentage, etc.) may be determined and returned from the model, as in 1018.

FIG. 11A is an example flow diagram of a 3D model adjustment process 1100, in accordance with implementations of the present disclosure. The example process 1100 begins by determining a pose of a body represented in one of the 2D body images, as in 1102. A variety of techniques may be used to determine the approximate pose of the body represented in a 2D body image. For example, camera parameters (e.g., camera type, focal length, shutter speed, aperture, etc.) included in the metadata of the 2D body image, may be obtained and/or additional camera parameters may be determined and used to estimate the approximate pose of the body represented in the 2D body image. For example, a 3D model may be used to approximate the pose of the body in the 2D body image and then a position of a virtual camera with respect to that model that would produce the 2D body image of the body may be determined. Based on the determined position of the virtual camera, the height and angle of the camera used to generate the 2D body image may be inferred. In some implementations, the camera tilt may be included in the metadata and/or provided by a device that includes the camera. For example, many portable devices include an accelerometer and information from the accelerometer at the time the 2D body image was generated may be provided as the tilt of the camera. Based on the received and/or determined camera parameters, the pose of the body represented in the 2D body image with respect to the camera may be determined, as in 1102.

The 3D model of the body may then be adjusted to correspond to the determined pose of the body in the 2D body image, as in 1104. A determination is then made as to which body landmarks of the body are visible in the 2D body image, as in 1106. For example, a defined set of body landmarks (e.g., left shoulder, right shoulder, left elbow, right elbow, right hip, left hip, etc.) may be defined and the 2D body image, segmented silhouette, and/or 3D model of the body may be processed to determine which of the set of body landmarks are visible in the 2D body image.

For each body landmark that is determined to be visible in the 2D body image, the corresponding body landmark in the 3D model is adjusted to correspond to the body landmark in the 2D body image, as in 1108. For example, the coordinates of the 3D body model may be overlaid with the 2D body image, and the body landmarks of the 3D model updated to correspond to the respective body landmarks as represented in the 2D body image. In some implementations, the location and/or shape of the body segments of the 3D model between body landmarks may also be updated to correspond or align with the updated body landmarks of the 3D model. For body landmarks that are determined to be occluded or out-of-view, the position data for that body landmark may not be considered and the body landmark in the 3D model not adjusted based on the body landmark determined from the 2D body image. However, in some implementations, the body landmark of the 3D body model that corresponds to a body landmark that is determined to be occluded or out of the field of view, may be adjusted based on the repositioning of other body landmarks that are visible in the 2D body image.

With the 3D model adjusted to approximately the same pose as the user represented in the 2D body image and the body landmarks of the 3D model aligned with the visible body landmarks of the 2D body image, the shape and position of each body segment of the 3D model may be compared to the shape of the corresponding visible body segments in the 2D body image and/or the body segments in the segmented silhouette to determine any differences between the body segments of the 3D model and the representation of the visible body segments in the 2D body image and/or segmented silhouette, as in 1110.

Additionally, in some implementations, for visible body segments represented in the 2D body image, it may be determined whether any determined difference is above a minimum threshold (e.g., 2%). If it is determined that there is a difference between a body segment of the 3D model and the body segment represented in one or more of the 2D body images, the segmented silhouette may be adjusted, as in 1112. The adjustment of body segments of the segmented silhouette may be performed in an iterative fashion, taking into consideration the difference determined for each body segment and adjusting the visible body segments.

FIG. 11B is an example flow diagram of another 3D model adjustment process 1150, in accordance with implementations of the present disclosure.

The example process 1150 begins by determining a pose of a body represented in one of the 2D body images, as in 1152. A variety of techniques may be used to determine the approximate pose of the body represented in a 2D body image. For example, camera parameters (e.g., camera type, focal length, shutter speed, aperture, etc.) included in the metadata of the 2D body image may be obtained and/or additional camera parameters may be determined and used to estimate the approximate pose of the body represented in the 2D body image. For example, a 3D model may be used to approximate the pose of the body in the 2D body image and then a position of a virtual camera with respect to that model that would produce the 2D body image of the body may be determined. Based on the determined position of the virtual camera, the height and angle of the camera used to generate the 2D body image may be inferred. In some implementations, the camera tilt may be included in the metadata and/or provided by a portable device that includes the camera. For example, many portable devices include an accelerometer and information from the accelerometer at the time the 2D body image was generated may be provided as the tilt of the camera. Based on the received and/or determined camera parameters, the pose of the body represented in the 2D body image with respect to the camera may be determined, as in 1152.

The 3D model of the body of the user may then be adjusted to correspond to the determined pose of the body in the 2D body image, as in 1154. A determination is then made as to which body landmarks of the body are visible in the 2D body image, as in 1156. For example, a defined set of body landmarks (e.g., left shoulder, right shoulder, left elbow, right elbow, right hip, left hip, etc.) may be defined and the 2D body image, segmented silhouette, and/or 3D model of the body may be processed to determine which of the set of body landmarks are visible in the 2D body image.

For each body landmark that is determined to be visible in the 2D body image, the corresponding body landmark in the 3D model is adjusted to correspond to the body landmark in the 2D body image, as in 1158. For example, the coordinates of the 3D body model may be overlaid with the 2D body image, and the body landmarks of the 3D model updated to correspond to the body landmarks as represented in the 2D body image. In some implementations, the location and/or shape of the body segments of the 3D model between body landmarks may also be updated to correspond or align with the updated body landmarks of the 3D model. For body landmarks that are determined to be occluded or out-of-view, the position data for that body landmark may not be considered and the body landmark in the 3D model not adjusted based on the body landmark determined from the 2D body image. However, in some implementations, the body landmark of the 3D body model that corresponds to a body landmark that is determined to be occluded or out-of-view in the 2D body image may be adjusted based on the repositioning of other body landmarks that are visible in the 2D body image.

With the 3D model adjusted to approximately the same pose as the user represented in the image and the body landmarks of the 3D model aligned with the visible body landmarks of the 2D body image, a 2D model image from the 3D model is generated, as in 1160. The 2D model image may be generated, for example, by converting or imaging the 3D model into a 2D model image with the determined pose, as if a digital 2D model image of the 3D model had been generated. Likewise, the 2D model image may be segmented to include body segments corresponding to body segments determined for the 3D model.

The body segments of the 2D model image are then compared with the visible body segments of the 2D body image and/or the segmented silhouette to determine any differences between the 2D model image and the representation of visible body segments of the body in the 2D body image and/or segmented silhouette, as in 1162. For example, the 2D model image may be aligned with the 2D body image and/or the segmented silhouette and pixels of each corresponding body segment that is visible in the 2D body image compared to determine differences between the pixel values. In implementations in which the pixels of body segments are assigned different color values, an error (e.g., % difference) may be determined as a difference in pixel values between the 2D model image and the 2D body image for each segment. For body segments that are determined to be not visible in the 2D body image, the pixel values may not be compared. The error determined for visible body segments is differentiable and may be utilized to adjust the size, shape, and/or position of each body segment and the resulting predicted body parameters, thereby updating the shape of the 3D model.

In some implementations, for visible body segments, it may be determined whether any determined difference is above a minimum threshold (e.g., 2%). If it is determined that there is a difference between a body segment of the 2D model image and the body segment represented in one or more of the 2D body images/segmented silhouette, the segment in the 3D model and/or the predicted body parameters may be adjusted to correspond to the shape and/or size of the body segment represented in the 2D body image and/or the segmented silhouette, as in 1164. This example process 1150 may continue until there is no difference between the segments of the 2D model image and the visible body segments represented in the 2D body image/segmented silhouette, or the difference is below a minimum threshold. As discussed above, the revised 3D model produced from the example process 1150, or if no adjustments are necessary, the 3D model is returned to example process 1000 at block 1012 and the process 1000 continues.

Although the disclosure has been described herein using exemplary techniques, components, and/or processes for implementing the systems and methods of the present disclosure, it should be understood by those skilled in the art that other techniques, components, and/or processes or other combinations and sequences of the techniques, components, and/or processes described herein may be used or performed that achieve the same function(s) and/or result(s) described herein and which are included within the scope of the present disclosure.

Additionally, in accordance with the present disclosure, the training of machine learning tools (e.g., artificial neural networks or other classifiers) and the use of the trained machine learning tools to generate physical activity feedback based on one or more 2D body images of that body may occur on multiple, distributed computing devices, or on a single computing device.

Furthermore, although some implementations of the present disclosure reference the use of separate machine learning tools or separate CNNs for determining visible body landmarks, occluded visible body landmarks, and/or out-of-view body landmarks, the systems and methods of the present disclosure are not so limited. Features, predicted body parameters, and/or 3D models may be determined and generated using a single CNN, or with two or more CNNs, in accordance with the present disclosure.

Likewise, while the above discussions focus primarily on generating physical activity feedback using multiple 2D body images of the body, in some implementations, the physical activity feedback may be generated based on a single 2D body image of the body.

Still further, while the above implementations are described with respect to generating physical activity feedback of human bodies represented in 2D body images, in other implementations, non-human bodies, such as dogs, cats, or other animals may be processed based on 2D representations of those bodies. Accordingly, the use of a human body in the disclosed implementations should not be considered limiting.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow charts shown in FIGS. 6 through 11B, orders in which such methods or processes are presented are not intended to be construed as any limitation on the claimed inventions, and any number of the method or process steps or boxes described herein can be combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD-ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method, comprising:
receiving a plurality of two-dimensional (“2D”) partial body images of a human body from a 2D camera, wherein:
each of the plurality of 2D partial body images are a time series of 2D partial body images;
each of the plurality of 2D partial body images represent less than all of the human body;
processing at least a portion of the plurality of 2D partial body images to at least:
determine a first plurality of body landmarks corresponding to the human body that are visible in the plurality of 2D partial body images; and
determine a second plurality of body landmarks corresponding to the human body that are not visible in the plurality of 2D partial body images;
determining, based at least in part on a first position of a first body landmark of the first plurality of body landmarks with respect to a second position of a second body landmark of the second plurality of body landmarks, that the human body is in a poor form with respect to an exercise being performed by the human body; and
sending, for presentation to the human body, an indication of the poor form and a correction to be made with respect to the poor form and the exercise.

2. The computer-implemented method of claim 1, further comprising:
determining, based at least in part on a first plurality of the body landmarks and the second plurality of body landmarks, the exercise.

3. The computer-implemented method of claim 1, wherein processing at least a portion of the plurality of 2D partial body images to determine the second plurality of body landmarks includes:
predicting positions of the second plurality of body landmarks based at least in part on positions of the first plurality of body landmarks.

4. The computer-implemented method of claim 1, wherein the second plurality of body landmarks are either out of a field of view of the 2D camera or are occluded from the field of view of the 2D camera.

5. The computer-implemented method of claim 1, further comprising:
determining, based at least in part on the first plurality of body landmarks and the second plurality of body landmarks, a plurality of repetitions of the exercise performed by the human body; and
sending, for presentation, a repetitions count indicative of the plurality of repetitions.

6. A computing system, comprising:
one or more processors;
a memory storing program instructions that, when executed by the one or more processors, cause the one or more processors to at least:
receive a two-dimensional (“2D”) partial body image of a body, wherein the 2D partial body image represents less than all of the body;
process the 2D partial body image to at least:
determine a first plurality of body landmarks corresponding to the body that are visible in the 2D partial body image; and
determine a second plurality of body landmarks corresponding to the body that are not visible in the 2D partial body image;
determine based at least in part on the first plurality of body landmarks and the second plurality of body landmarks, an accuracy of a form of the body with respect to a physical activity being performed by the body; and
send, for presentation, a feedback indicating the accuracy of the form of the body with respect to the physical activity.

7. The computing system of claim 6, wherein:
the program instructions that, when executed by the one or more processors to determine the accuracy of the form, further include instructions that, when executed by the one or more processors, further cause the one or more processors to at least determine, based at least in part on at least a first portion of the first plurality of body landmarks and at least a second portion of the second plurality of body landmarks, that the body is in a proper form when performing the physical activity; and
the feedback indicates that the body is in the proper form.

8. The computing system of claim 6, wherein:
The program instructions that, when executed by the one or more processors to determine the accuracy of the form, further include instructions that, when executed by the one or more processors, further cause the one or more processors to at least determine, based at least in part on at least a first portion of the first plurality of body landmarks and at least a second portion of the second plurality of body landmarks, that the body is in an improper form when performing the physical activity; and
the feedback indicates a correction to be made by the body to resolve the improper form.

9. The computing system of claim 8, wherein the program instructions that, when executed by the one or more processors to determine that the body is in the improper form, further include instructions that, when executed by the one or more processors, further cause the one or more processors to at least:
process at least the first portion of the first plurality of body landmarks and at least the second portion of the second plurality of body landmarks to determine a form error value;
determine that the form error value exceeds a threshold; and
in response to determination that the form error value exceeds the threshold, generate the feedback.

10. The computing system of claim 6, wherein the program instructions that, when executed by the one or more processors, further cause the one or more processors to at least:
determine, based at least in part on a first position of the first plurality of body landmarks and second position of the second plurality of body landmarks, the physical activity being performed by the body.

11. The computing system of claim 6, wherein the program instructions that, when executed by the one or more processors, further cause the one or more processors to at least:
determine, based at least in part on a first position of the first plurality of body landmarks and a second position of the second plurality of body landmarks, at least one of:
a start of a repetition of the physical activity; or
an end of the repetition of the physical activity.

12. The computing system of claim 11, wherein the program instructions that, when executed by the one or more processors, further cause the one or more processors to at least:
update a repetition count that is presented based at least in part on the start of the repetition or the end of the repetition.

13. The computing system of claim 6, wherein the presentation is at least one of a visual presentation, an audible presentation, or a haptic presentation.

14. The computing system of claim 6, wherein the program instructions that, when executed by the one or more processors to determine the second plurality of body landmarks, further include instructions that, when executed by the one or more processors, further cause the one or more processors to at least:
predict positions of the second plurality of body landmarks based at least in part on positions of the first plurality of body landmarks.

15. The computing system of claim 6, wherein the program instructions that, when executed by the one or more processors, further cause the one or more processors to at least:
generate, based at least in part on the 2D partial body image, a 3D body model of the body; and
wherein the accuracy of the form of the body is further based at least in part on the 3D body model.

16. A method, comprising:
processing a first two-dimensional (“2D”) body image that includes a representation of a body from a first view to produce a first plurality of body landmarks corresponding to the body that are visible in the first 2D body image;
determining, based at least in part on the first plurality of body landmarks, a second plurality of body landmarks corresponding to a second portion of the body that is not represented in the first 2D body image;
determining, based at least in part on at least a first portion of the first plurality of body landmarks and at least a second portion of the second plurality of body landmarks, an accuracy of a form of the body with respect to a physical activity being performed by the body; and
causing a presentation of a feedback with respect to the accuracy of the physical activity.

17. The method of claim 16, wherein the feedback indicates at least one of a correction to be made with respect to the form of the body or a confirmation that the form of the body is proper with respect to the physical activity.

18. The method of claim 16, further comprising:
determining, based at least in part on the first plurality of body landmarks and the second plurality of body landmarks, a repetition count indicating a number of repetitions of the physical activity performed by the body; and
wherein the physical activity is an exercise.

19. The method of claim 16, wherein the second plurality of body landmarks are determined by a machine learning model that is trained to predict positions of body landmarks for a body that are not represented in a 2D body image based at least in part on positions of body landmarks input into the machine learning model.

20. The method of claim 16, wherein the at least one of the second plurality of body landmarks that is not visible is at least one of beyond a field of view represented in the first 2D body image, occluded by the body, or occluded by an object.
